(19) United States
(12) Patent Application Publication
(10) Pub. No.: US 2007/0069041 A1
(43) Pub. Date: Mar. 29, 2007

(54) Viscous material dispensing systems with parameter monitoring and methods of operating such systems

(75) Inventors: Horatio Quinones, Carlsbad, CA (US); Thomas Laferl Ratledge, San Marcos, CA (US); Robert Ciardella, Rancho Santa Fe, CA (US); Alec Babiarz, Encinitas, CA (US); Erik Fiske, Carlsbad, CA (US); Mark Meier, Encinitas, CA (US); Chris Giusti, San Marcos, CA (US); Liang Fang, San Diego, CA (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation

(21) Appl. No.: 11/235,877

(22) Filed: Sep. 27, 2005

(51) Int. Cl. A01G 27/00; B67D 5/08

(52) U.S. Cl. 239/71; 239/73; 239/67

(57) ABSTRACT

Systems and methods for dispensing or jetting a viscous material. The systems include an electronic controller and a jetting dispenser operatively coupled with the electronic controller. The systems further include at least one sensor that senses a system dispensing parameter and communicates an output signal representing the sensed parameter to the electronic controller for controlling system operation. In pneumatically-actuated jetting dispensers, a sensor may sense the fluid pressure in the air cavity of the pneumatic actuator. In jetting dispensers with a movable needle valve, a sensor may sense the displacement of the needle shaft. In other jetting dispensers, a sensor may sense the vibration of the jetting dispenser.

### FIELD OF THE INVENTION

The present invention generally relates to equipment for dispensing viscous materials and more particularly, to viscous material dispensing systems for a dispensing viscous material onto a substrate without contacting the substrate.

### BACKGROUND OF THE INVENTION

Non-contact viscous material dispensers are often used to apply minute amounts of viscous materials, i.e. those with a viscosity exceeding fifty centipoise, onto substrates. For example, non-contact viscous material dispensers are used to apply various viscous materials onto electronic substrates like printed circuit boards. Viscous materials applied to electronic substrates include, by way of example and not by limitation, general purpose adhesives, solder paste, solder flux, solder mask, thermal grease, lid sealant, oil, encapsulants, potting compounds, epoxies, die attach fluids, silicones, RTV, and cyanoacrylates.

Specific applications abound for dispensing viscous materials from a non-contact dispenser onto a substrate. In semiconductor package assembly, applications exist for underfilling, solder ball reinforcement in ball grid arrays, dam and fill operations, chip encapsulation, underfilling chip scale packages, cavity fill dispensing, die attach dispensing, lid seal dispensing, no flow underfilling, flux jetting, and dispensing thermal compounds, among other uses. For surface-mount technology (SMT) printed circuit board (PCB) production, surface mount adhesives, solder paste, conductive adhesives, and solder mask materials may be dispensed from non-contact dispensers, as well as selective flux jetting. Conformal coatings may also be applied selectively using a non-contact dispenser. Generally, the cured viscous materials protect printed circuit boards and mounted devices thereupon from harm originating from environmental stresses like moisture, fungus, dust, corrosion, and abrasion. The cured viscous materials may also preserve electrical and/or heat conduction properties on specific uncoated areas. Applications also exist in the disk drive industry, in life sciences applications for medical electronics, and in general industrial applications for bonding, sealing, forming gaskets, painting, and lubrication.

Automated systems are known that include a non-contact viscous material dispenser mounted on a robotic system, which moves the dispenser relative to the recipient substrate. Substrates are supplied from a material handler and conveyed serially past the viscous material dispenser. The system is equipped to precisely dispense amounts of viscous material reproducibly from the viscous material dispenser at targeted locations on each substrate.

Several variables may be controlled to provide a high quality viscous material dispensing process. Among the parameters that are known to influence the dispensed weight or dot size are the supply pressure of the viscous material, the temperature of the viscous fluid, the on-time of a dispensing valve within the dispenser, the stroke and preload bias of a needle valve in the dispensing valve, and the air pressure supplied to the dispensing valve. In appreciation of the importance of establishing and maintaining consistency for the dispensed dot size, conventional systems may monitor the temperature of the viscous material and, if the temperature strays from a set point, apply a correction. However, conventional systems do not monitor others of the influencing parameters, such as the air pressure supplied to the dispensing valve, that are constantly changing, albeit, often only slightly over the short term; but the cumulative effect of such changes can result in a detectable change in the dispensed dot size. Consequently, a deficiency of conventional viscous material dispensing systems is that these systems cannot detect and compensate for a change in a dispensing parameter other than the temperature of the viscous material.

Therefore, there is a need for an improved computer controlled viscous fluid dispensing system that can detect changes in an operational parameter of the system, other than the temperature of the dispensed viscous material, and track and/or respond to those detected operational parameter changes.

### SUMMARY OF THE INVENTION

According to the principles of the present invention and in accordance with the described embodiments, one aspect of the invention is a system for jetting a viscous material that includes a jetting dispenser coupled with an electronic controller for operational control. The jetting dispenser has an outlet orifice and an actuator with a movable shaft. The jetting dispenser is operative under control of the electronic controller for causing the actuator to jet an amount of the viscous material from the outlet orifice. The system further includes a displacement sensor configured to sense movement of the movable shaft and produce an output signal representative of the sensed movement.

According to the principles of the present invention and in accordance with the described embodiments, another aspect of the invention is a system for jetting a viscous material including a jetting dispenser coupled with an electronic controller for operational control. The jetting dispenser includes an actuator with an air cylinder and an air piston positioned in the air cylinder. The jetting dispenser is operative under control of the electronic controller for causing the actuator to jet an amount of the viscous material from an outlet orifice of the jetting dispenser. The system further includes a pressure sensor configured to sense a fluid pressure inside the air cylinder and produce an output signal representative of the sensed fluid pressure, which may change as the air piston moves within the air cylinder.

According to the principles of the present invention and in accordance with the described embodiments, another aspect of the invention is a system for jetting a viscous material including a jetting dispenser coupled with an electronic controller for operational control. The jetting dispenser is operative under control of the electronic controller for causing an actuator of the jetting dispenser to jet an amount of the viscous material from an outlet orifice of the jetting dispenser. The system further includes a vibration sensor configured to sense vibration of the jetting dispenser during operation.

According to the principles of the present invention and in accordance with the described embodiments, another aspect of the invention is a method of operating a jetting system that includes a jetting dispenser having an actuator with an air cylinder and an air piston movable within the air cylinder, and a control component operatively coupled with the jetting dispenser. The jetting system operates the actuator under the control of the control component to jet a viscous material from an outlet orifice of the jetting dispenser. The method comprises supplying pressurized fluid to the air cylinder effective to move the air piston relative to the air cylinder, sensing a fluid pressure inside the air cylinder as the air piston moves within the air cylinder, and communicating the sensed fluid pressure to the control component.

According to the principles of the present invention and in accordance with the described embodiments, another aspect of the invention is a method of operating a jetting system that includes a jetting dispenser with a movable shaft and a control component operatively coupled with the jetting dispenser. The method comprises moving the movable shaft within the jetting dispenser, sensing a displacement of the movable shaft during movement, and communicating the sensed displacement to the control component.

According to the principles of the present invention and in accordance with the described embodiments, another aspect of the invention is a method of operating a jetting system that includes a jetting dispenser with at least one movable component and a control component operatively coupled with the jetting dispenser. The method comprises moving the at least one movable component of the jetting dispenser, sensing vibration of the jetting dispenser resulting from movement of the at least one movable component, and communicating the sensed vibration to the control component.

Advantageously, the sensors of the invention do not provide an indication of the temperature of the dispensed viscous material or the temperature of the jetting dispenser as the inventive monitored operational parameter. However, the viscous material jetting systems of the invention may also monitor the temperature of the dispensed viscous material or the jetting dispenser. In that situation, an operational parameter (e.g., shaft movement) in addition to temperature is monitored in accordance with the principles of the invention. The viscous material jetting systems of the invention advantageously detect a change in an operational parameter of the system, other than the temperature of the dispensed viscous material, and track and/or respond to those detected operational parameter changes.

These and other benefits and advantages of the present invention will become more readily apparent during the following detailed description taken in conjunction with the drawings herein.

### BRIEF DESCRIPTION OF THE DRAWINGS

FIG. 1 is a schematic representation of a viscous material jetting system in accordance with an embodiment of the present invention;

FIG. 2 is a schematic block diagram of the viscous material jetting system of FIG. 1;

FIG. 3 is a schematic plot showing the information derived from the use of an fluid pressure sensor and a displacement sensor in the viscous material jetting system of FIGS. 1 and 2;

FIG. 4 is a flow chart generally illustrating an embodiment of a procedure for establishing a reference standard for sensed dispensing parameters during the operation of the viscous material jetting system of FIGS. 1 and 2;

FIG. 5 is a flow chart generally illustrating an embodiment of a procedure for operating the viscous material jetting system of FIGS. 1 and 2 while monitoring dispensing parameters;

FIG. 6 is a flow chart generally illustrating an embodiment of a procedure for setting up the viscous material jetting system of FIGS. 1 and 2 to operate with a vibration reference standard; and

FIG. 7 is a flow chart generally illustrating an embodiment of a procedure for operating the viscous material jetting system of FIGS. 1 and 2 during a production run using the vibration sensor to monitor the performance of the droplet generator.

### DETAILED DESCRIPTION OF THE INVENTION

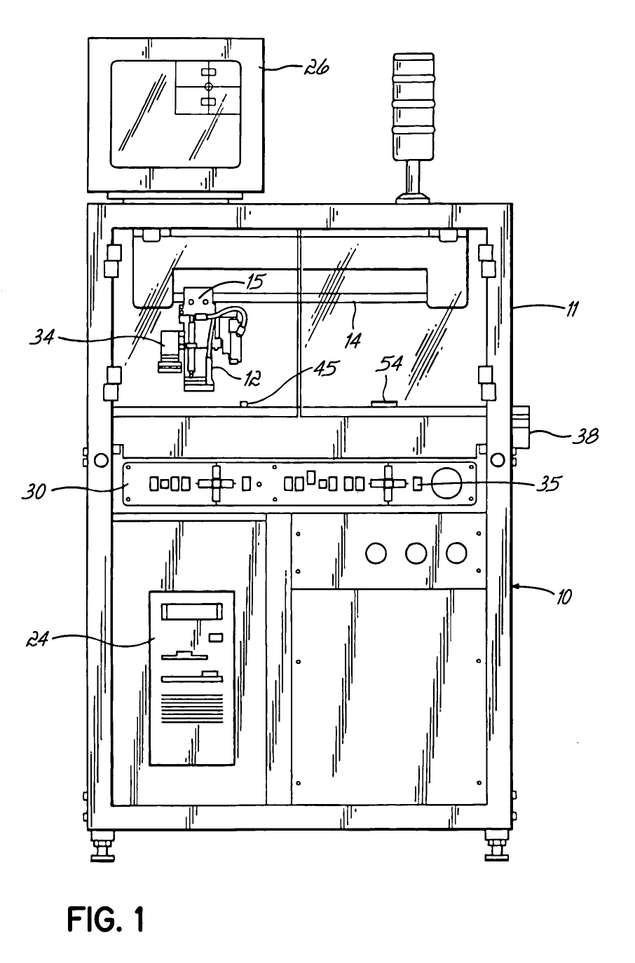

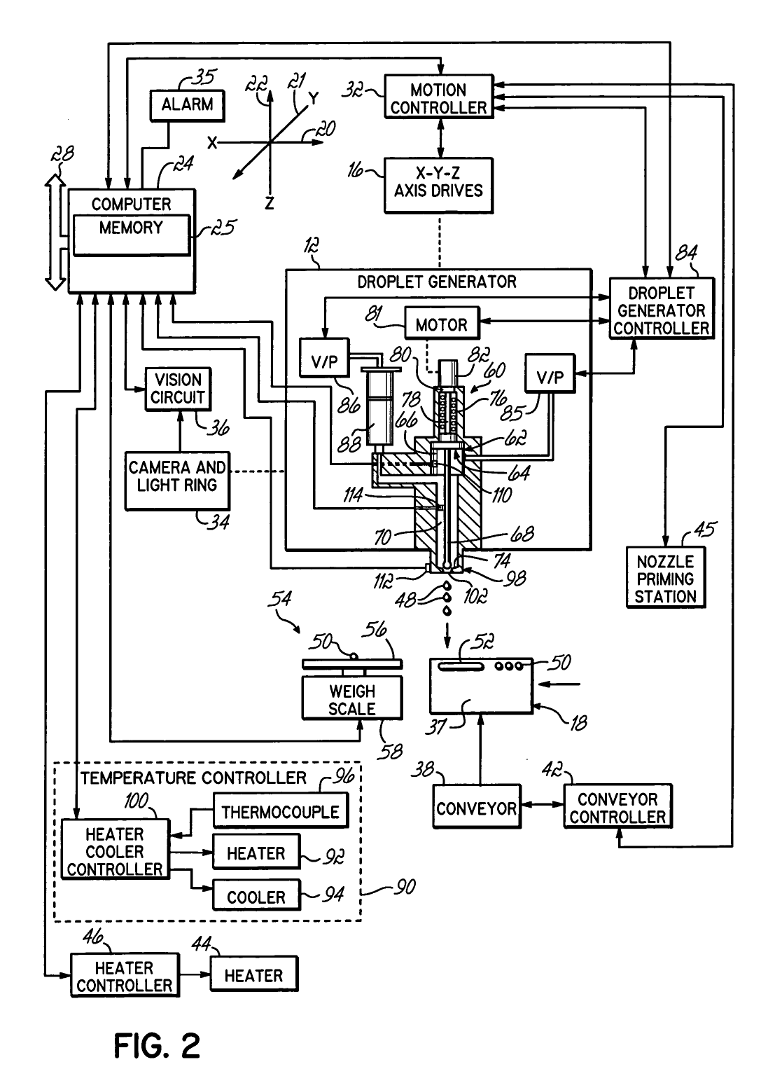

With reference to FIGS. 1 and 2, a viscous material jetting system 10 includes a cabinet 11 consisting of a framework of interconnected horizontal and vertical beams partially covered by panels. The jetting system 10 includes a viscous material droplet generator 12 for dispensing amounts of a viscous material, for example, an adhesive, epoxy, solder, etc. The viscous material droplet generator 12 is mounted on a Z-axis drive mechanism 15 and suspended from an X-Y positioner 14 supported by the cabinet 11. The X-Y positioner 14 is operated by a pair of independently controllable axis drives 16 in a known manner. The X-Y positioner 14 and Z-axis drive mechanism 15 provide three substantially perpendicular axes of motion for the droplet generator 12.

Axis drives 16 are capable of rapidly moving the droplet generator 12 over the surface of a substrate 18, such as a printed circuit board. The axis drives 16 include the electromechanical components of the X-Y positioner 14 and the Z-axis drive mechanism 15, such as the motors and drive circuitry, to provide X, Y and Z axes of motion 20, 21, 22, respectively. Although the droplet generator 12 may be raised and lowered using the Z-axis drive mechanism 15 to dispense viscous material from other various heights above the substrate 18 or to clear components mounted on the substrate 18, the droplet generator 12 normally jets droplets of viscous material from a single fixed height. The jetting system 10 may be, for example, of the type commercially available from Asymtek (Carlsbad, Calif.).

A computer 24 is mounted in the lower portion of the cabinet 11 for providing the overall control for the system 10. The computer 24 may be a programmable logic controller (“PLC”) or another microprocessor-based controller capable of executing software stored in a memory 25 and carrying out the functions described herein, as will be understood by those of ordinary skill. The computer 24 has a suitable user interface (not shown), such as an alphanumeric keyboard and/or a pointing device, capable of accepting commands or input from the operator and transmitting the input to the data processing unit of computer 24. The computer 24 displays information to the operator in a suitable graphical format on a video display 26. The computer 24 may be provided with standard RS-232 and SMEMA CIM communications busses 28, which are compatible with most types of other automated equipment utilized in substrate production assembly lines.

A control panel 30, which may be mounted on the cabinet 11, includes a plurality of push buttons for manual initiation of certain functions, for example, during set-up, calibration, and viscous material loading. The control panel 30 may further include an alarm indicator 35 that displays to the operator that an alarm condition, such as an irregularity or abnormality in needle displacement, air pressure to the needle valve, detected vibration, etc. exists. Alternatively, the display 26 may be used to display the alarm indicator 35 either instead of alarm indicator 35 or in addition to alarm indicator 35. Although the alarm indicator 35 is shown as coupled with the computer 24, the invention is not so limited as the alarm indicator 35 may be independent of computer 24. Instead of an alarm indicator, the system 10 may include a kill switch or the like to remove the power to one or more components of system 10 in response to an alarm condition.

A motion controller 32, which is electrically coupled with the computer 24 and with the axis drives 16, controls the three-dimensional movement of the droplet generator 12 and an accompanying video camera and light ring assembly 34. The motion controller 32 is in electrical communication with each of the axis drives 16 and provides command signals, under the instruction of computer 24, to separate drive circuits of the individual axis drives 16 for respective X, Y and Z axis motors in a known manner. The computer 24 typically instructs the motion controller 32 to move the axis drives 16 in a scripted manner that is repeated for a series of substrates 18.

The video camera and light ring assembly 34 is connected to the droplet generator 12 for simultaneous motion along the X, Y and Z axes 20, 21, 22 to inspect dots and locate reference fiducial points on substrate 18. The video camera and light ring assembly 34 may be of the type described in U.S. Pat. No. 5,052,338, the disclosure of which is hereby incorporated by reference herein in its entirety. The camera and light ring assembly 16 is electrically coupled with a vision circuit 36, which powers the light ring for illuminating an upper surface 37 of the substrate 18. The vision circuit 36 also receives and transfers images from the video camera in the assembly 34, which may be a charge coupled device, to the computer 24 for use during jetting operations.

Substrates 18, which are to receive amounts of viscous material, are horizontally transported directly beneath the droplet generator 12 by a conveyor 38. The conveyor 38, which is of conventional design, has a width that can be adjusted to accept substrates 18 of different dimensions. The conveyor 38 also includes pneumatically operated lift and lock mechanisms (not shown). The conveyor 38 moves each substrate 18 to a desired position near the droplet generator 12, as indicated by the horizontal single-headed arrow 40 in FIG. 2.

With continued reference to FIGS. 1 and 2, a conveyor controller 42 is connected to the substrate conveyor 38. The conveyor controller 42 provides an interface between the motion controller 32 and the conveyor 38, under the instruction of computer 24, for controlling the width adjustment and lift and lock mechanisms of the conveyor 38. The conveyor controller 42 also controls the transfer of the substrates 18 through the system 10 during the viscous material application process.

A substrate heater 44 is operative in a known manner to heat the substrates 18 and to maintain a desired temperature profile of the viscous material as the substrates 18 are conveyed through the system 10. The substrate heater 44 is operated by a heater controller 46 in a known manner. A nozzle priming station 45 may also be provided to prime the droplet generator 12 with viscous material.

The droplet generator 12 jets droplets or amounts 48 of viscous material downwardly toward the upper surface 37 of the substrate 18. The viscous material amounts 48, which impact the upper surface 37, are applied on the substrate 18 as viscous material dots 50. The substrate 18 may be of the type carrying surface-mounted components, which necessitates jetting the minute viscous material amounts 48 rapidly and with accurate placement to form viscous material dots 50 at targeted locations on the substrate 18. The droplet generator 12 may be operated such that a succession of jetted amounts 48 form a line 52 of viscous material dots on the upper surface 37 of substrate 18. As used herein, the term “jetting” refers to a process for forming viscous material amounts 48 and dots 50 or lines 52.

A calibration station 54 is used for calibration purposes to provide a dot size calibration for accurately controlling the weight or size of the dispensed amounts 48 and a dot placement calibration for accurately locating viscous material amounts 48 that are dispensed on-the-fly, that is, while the droplet generator 12 is moving relative to the substrate 18. In addition, the calibration station 54 is used to provide a material volume calibration for accurately controlling the velocity of the droplet generator 12 as a function of current material dispensing characteristics, the rate at which the amounts 48 are to be dispensed, and a desired total volume of viscous material to be dispensed in a pattern of dots 50, for example, in the line 52. The calibration station 54 includes a stationary work surface or table 56 and a measuring device, for example, a weigh scale 58. The weigh scale 58, which is electrically coupled with the computer 24, supplies a feedback signal to the computer 24 representing size-related physical characteristic of the dispensed viscous material, which in this embodiment is the weight of material weighed by the scale 58. The computer 24 compares the weight of the material with a previously determined specified value, for example, a viscous material weight set point value stored in the computer memory 25. Other types of devices may be substituted for the weigh scale 58 for measuring the diameter, area and/or volume of the dispensed material in dots 50 or line 52.

Because the droplet generator 12 may be implemented using different designs, the specific embodiments described herein are to be considered exemplary, and limiting, of the present invention. The droplet generator 12 includes a jetting dispenser 60, which is a non-contact dispenser specifically designed for jetting minute amounts of viscous material. The dispenser 60 includes an actuator or needle valve 62 including an air piston 64 disposed in an air cylinder 66 and a lower rod or shaft 68 extending from the air piston 68 into a material chamber 70. A distal lower end 72 of the shaft 68 is biased into contact with a valve seat 74 by a return spring 76. When contacting, the lower end 72 is geometrically shaped to provide a seal with the valve seat 74. Thus, the needle valve 62 is closed by the lower end 72 contacting and bearing against the valve seat 74, and the needle valve 62 is opened by moving the lower end 72 away from the valve seat 62, thereby permitting a downstream flow of viscous material through an annular gap between the lower end 72 and the valve seat 62.

Extending upwardly from the air piston 64 is an upper rod 78 having a distal upper end disposed adjacent a stop surface define on the end of a screw 80 of a micrometer 82. Adjusting the micrometer screw 80 changes the upper limit of the stroke of the air piston 64 and, therefore, of the shaft 68. Moreover, adjustment of the micrometer screw 80 may also be used to set an initial spring compression of return spring 76, which determines the preloading for the needle valve 62. A motor 81, which is controlled by instructions from a droplet generator controller 84, may be mechanically coupled to the micrometer screw 80. Consequently, the droplet generator controller 84 may automatically adjust the stroke of the piston 64, which varies the volume of viscous material in each jetted amount. Jetting dispensers of the type described above are more fully described in U.S. Pat. Nos. 6,253,957 and 5,747,102, the entire disclosures of which are hereby incorporated herein by reference.

The droplet generator controller 84 is electrically coupled with a voltage-to-pressure transducer 85, for example, an air piloted fluid regulator, one or more pneumatic solenoids, etc., connected to a pressurized fluid source (not shown). The droplet generator controller 70 is configured to provide an output pulse to transducer 85, which responds by porting a pulse of pressurized air into the air cylinder 66 and produces a rapid lifting of the air piston 66 that lifts the lower end 72 of the shaft 68 away from valve seat 74 and further compresses the return spring 76. Lifting the lower rod 68 from the valve seat 74 draws viscous material in the chamber 70 between the lower end 72 and the valve seat 74 and downstream from the valve seat 74.

With continued reference to FIGS. 1 and 2, the droplet generator controller 84 is also electrically coupled with a voltage-to-pressure transducer 86, for example, an air piloted fluid regulator, one or more pneumatic solenoids, etc. The transducer 86 is connected to a pressurized source of fluid (not shown), that, in turn, ports pressurized air to a supply reservoir 88, which is holds a supply of the viscous material. The supply reservoir 88, which may have the form of a filled syringe cartridge, communicates with the chamber 70 for continuously receiving volumes of the viscous material as required by the dispensing operation. Thus, the supply reservoir 88 supplies pressurized viscous material to the chamber 70 for use in jetting the amounts 48.

The non-contact jetting system 10 further includes a temperature controller 90 including a heater 92, a cooler 94 and a temperature sensor, for example, a thermocouple 96, disposed immediately adjacent a nozzle 98 mounted to the jetting dispenser 60. The heater 92 may be a resistance heater that transfers heat to the nozzle 98. The cooler 94 may be any applicable device, for example, a Peltier device, a source of cooler air, a vortex cooling generator that is connected to a source of pressurized air, etc. The specific commercially available devices chosen to provide heating and cooling will vary depending on the environment in which the non-contact jetting system 10 is used, the viscous material being used, the heating and cooling requirements, the cost of the heating and cooling devices, the design of the system, for example, whether heat shields are used, and other application related parameters. The thermocouple 96 provides a feedback signal representative of the measured temperature to a heater/cooler controller 100, which is in electrical communications with the computer 24. The controller 100 operates the heater 92 and cooler 94 in order to maintain the nozzle 98 at a desired temperature above ambient temperature, as represented by a temperature set point, and to thereby regulate the temperature and viscosity of the jetted amounts 48 of viscous material. Thus, the temperature of the nozzle 98 and the viscous material therein is accurately controlled while it is located in and being ejected from the nozzle 98, thereby providing a higher quality and more consistent dispensing process.

In use, computer 24 initiates a jetting operation by providing a command signal to the droplet generator controller 84, which causes the controller 84 to provide an output pulse to the voltage-to-pressure transducer 85. The pulsed operation of the transducer 85 ports a pulse of pressurized air from the pressurized fluid source (not shown) into the air cylinder 66 and produces a rapid lifting of the air piston 64. Lifting the lower end 72 of the shaft 68 from the valve seat 74 draws viscous material from the chamber 70 to a location between the piston shaft 68 and the valve seat 74 and downstream of the valve seat 74. For the extent of the output pulse, the lower end 72 is displaced from the valve seat 74 and the pressurized viscous material is urged from chamber 70 into and through the annular opening between the lower end 72 and valve seat 74. The duration of the output pulse (i.e., on-time) determines the volume of viscous liquid available for dispensing as amount 48. At the conclusion of the output pulse, the transducer 85 returns to its original state, thereby releasing the pressurized air in the air cylinder 66, and the return spring 76 rapidly lowers the lower end 72 of the shaft 68 back against the valve seat 74. In that process, one amount 48 of viscous material is rapidly extruded or jetted through an opening or outlet orifice 102 of nozzle 98.

As schematically shown in exaggerated form in FIG. 2, the viscous material amount 48 breaks away because of its own forward momentum. Momentum propels the viscous material amount 48 toward the upper surface 37 of substrate 18, where it is applied on contact as one of the viscous material dots 50. The dispenser 60 is capable of jetting amounts 48 of viscous material from the nozzle 98 at very high rates, for example, up to 100 or more minute amounts per second.

With continued reference to FIGS. 1 and 2, the viscous material droplet generator 12 further includes at least one transducer or sensor 110, 112, 114 capable of measuring a parameter associated with the operation of the jetting dispenser 60. Parametric information from each sensor 110, 112, 114 is communicated to the computer 24 for controlling the operation of droplet generator 12 with commands issued to the droplet generator controller 84 and, in particular, controlling the operation of the jetting dispenser 60. The computer 24 may create a time profile for the measured parameter that is stored in memory 25 and, optionally, displayed to the operator on display 26. The parameter time profile may be used in analyzing or monitoring system operation and performance. The measured parameter(s), which are monitored in real time, are used to determine the operational quality of the droplet generator 12 and/or to adjust the parameter(s) to improved process control. The invention contemplates that the output signal from each of the sensors 110, 112, 114 may be communicated to another control component, such as the droplet generator controller 84, for consideration and/or analysis. The output signal(s) may alternatively be communicated to a remote location, either on-site of the system 10 or off-site, for evaluation. The output signal(s) may alternatively be relayed to circuitry carried directly by a system component, such as a drive circuit for motor 81. In other alternative embodiments, the output signal(s) may be communicated to, for example, a power source (not shown) for the system 10, which may discontinue or kill the power to the system 10 if the output signals(s) are sufficiently out of tolerance.

The deviation between the measured and expected parameter values may arise during a production run, during system setup, or during system troubleshooting by a service technician. The parameter deviation may originate from irregularities or anomalies in system components that occur during system operation. Generally, each monitored parameter is given a tolerance range, which is stored in the memory 25 of computer 24, for the discrepancy between measured and expected values (e.g., +10% of a targeted value) of a parameter. If the measured value is outside of the tolerance range, the computer 24 may respond accordingly. For example, the computer 24 may respond by instructing the droplet generator controller 84 to adjust the operation of the droplet generator 12 and/or the jetting dispenser 60 to correct the out-of-tolerance parameter. For example, the computer 24 may instruct the droplet generator controller 84 to operate motor 81 to adjust the stroke length of the shaft 68. An out-of-tolerance (i.e., irregular or abnormal) condition may also be indicated to an operator of system 10 via alarm indicator 35 or in a different manner that is independent of the computer 24. If a significant deviation is observed, the computer 24 may halt an executing production run of the system 10. Generally, an out-of-tolerance parameter will be reflected in loss or deterioration in dot quality in the jetted amounts 48.

One such sensor may be a fluid pressure sensor 110 communicating with the environment inside the air cylinder 66 and configured to measure the fluid pressure inside the air cylinder 66. Pressure sensor 110 is electrically coupled with the computer 24 and communicates an indication of the measured fluid pressure inside the air cylinder 66 as an electrical signal over a communication link, such as a wire, radiofrequency (RF) link, or infrared (IR) link, to the computer 24 or, optionally, to another control component. The pressure sensor 110 may measure the fluid pressure inside the air cylinder 66 intermittently or continuously. The computer 24 may relate the measured fluid pressure in the air cylinder 66 to the condition of the air piston 64. The computer 24 uses the digital signals, which are proportional to the measured pressure, communicated from the pressure sensor 110 to instruct the droplet generator controller 84 to control the operation of the droplet generator 12 and, in particular, the jetting dispenser 60.

The fluid pressure sensor 110 may be any conventional type of pressure sensing device capable of measuring or sensing fluid pressure and generating an analog or digital electrical signal indicating the sensed pressure. If needed, the computer 24 may include an analog-to-digital converter (ADC) to convert analog signals communicated from the pressure sensor 110 into a usable digital form. Pressure sensor 110 may be configured to measure either total pressure or static pressure, and may be any one of numerous pressure sensing devices known in the art including, but not limited to, a capacitance sensor, a strain gauge sensor, a piezoresistive sensor, and a thermal sensor.

The computer 24 analyzes the electrical signals communicated from the fluid pressure sensor 110 to indicate, for example, an irregularity or variation in the operation of the jetting dispenser 60. As a specific example, the computer 24 may compare a standard vibration output or reference to the analyzed movement output communicated from the pressure sensor 110 and, based upon the result of the comparison, indicate an irregularity in the operation of the jetting dispenser 60. The operation of the droplet generator 12 and/or the jetting dispenser 60 may be adjusted under the control of computer 24 to compensate for any detected changes in the fluid pressure supplied to the air cylinder 66.

The fluid pressure sensor 110 may be placed at any appropriate location on the body of the jetting dispenser 60 that permits the sensor 110 to communicate with the environment or atmosphere inside air cylinder 66. Alternatively, the pressure sensor 110 may be associated with the voltage-to-pressure transducer 85 or the fluid line(s) coupling the transducer 85 hydraulically with the air cylinder 66 inside the jetting dispenser 60. The invention contemplates that the air cylinder 66 may be a double-acting air cylinder in which fluid pressure is applied to both sides of the air piston 64, which partitions the air cylinder 66 in this instance into two cavities each with a separate air port. In this instance, separate pressure sensors 110 may monitor the fluid pressure in the each of the individual cavities inside the air cylinder 66.

Another type of sensor that may be coupled with the jetting dispenser 60 is vibration sensor 112, which may comprise an accelerometer or shock sensor, electrically coupled with the computer 24. The vibration sensor 112 is configured to measure or sense vibration of the jetting dispenser 60 as the shaft 68 moves in response to the operation of transducer 85 between the opened position in which the lower end 72 is lifted from the valve seat 74 to open the needle valve 62 and the closed position in which the lower end 72 impacts the valve seat 74 to close the needle valve 62. The vibration originates from the reciprocating linear movement of the shaft 68 and repeated impacts between the lower end 72 and the valve seat 74.

The vibration sensor 112 communicates an indication of the sensed vibration of the jetting dispenser 60 as electrical signal over a communication link, such as a wire, RF link, or IR link, to the computer 24 or, optionally, to another control component. The computer 24 uses the digital signals communicated from the vibration sensor 112 to instruct the droplet generator controller 84 to control the operation of the droplet generator 12 and, in particular, the operation of jetting dispenser 60.

The vibration sensor 112 may be any conventional type of vibration sensor capable of sensing vibrations and generating an analog or digital signal indicating the frequency and amplitude of sensed vibrations. If needed, the computer 24 may include an ADC to convert analog signals proportional to the measured vibration frequency and amplitude into a usable digital form. The vibration sensor 112 may be configured to sense vibrations in a single direction, or in multiple directions, such as a triaxial accelerometer.

Exemplary vibration sensors 112 include the EGA series of accelerometers commercially available from Entran Sensors & Electronics (Fairfield, N.J.). Accelerometers generally include a Wheatstone bridge consisting of strain gages (not shown) and a sensing member (not shown) associated with the stain gages. Acceleration from vibration causes deformation in the sensing member that in turn creates strain in the strain gages and, thereby, produces an imbalance in the Wheatstone bridge. The Wheatstone bridge imbalance produces a voltage change at a bridge output that is proportional to the physical input to the sensing member. The voltage change represents an electrical signal communicated to the compute 24.

The computer 24 analyzes the electrical signals communicated from the vibration sensor 112 to indicate, for example, an irregularity or variation in the operation of the jetting dispenser 60. As a specific example, the computer 24 may compare a standard vibration output or reference to the analyzed vibration output communicated from the vibration sensor 112 over a complete or partial cycle required to jet a single amount 48 of viscous material and indicate an irregularity in the operation of the jetting dispenser 60 based upon the comparison result. The operation of the droplet generator 12 and/or the jetting dispenser 60 may be adjusted under the command of computer 24 to compensate for any detected changes. In addition, a change in the vibration profile may indicate system component wear and/or a malfunctioning or damaged system component.

The vibration sensor 112 may be placed at any appropriate location on the nozzle 98 for sensing vibrations. For example, the vibration sensor 112 may be placed or attached on the exterior of the body of the nozzle 98 or, alternatively, may be otherwise integrated into the body of the nozzle 98. The vibration sensor 112 may also be positioned upstream from the nozzle 98 and either attached to, or integrated into, the body of the jetting dispenser 60.

Yet another type of sensor that may be coupled with the jetting dispenser 60 is a displacement sensor 114 electrically coupled with the computer 24. The displacement sensor 114 is configured to measure movement of the shaft 68 of the jetting dispenser 60 as the shaft 68 moves between the opened and closed positions in response to the operation of transducer 85. The displacement sensor 114 communicates an indication of the measured movement of shaft 68 as electrical signal over a communication link, such as a wire, RF link, or IR link, to the computer 24 or, optionally, to another control component. The displacement sensor 114 may be any conventional type of displacement sensor capable of sensing the motion of a shaft and generating an analog or digital signal indicating the frequency and amplitude of the sensed shaft motion. The computer 24 uses the digital signals communicated from the displacement sensor 114 to instruct the droplet generator controller 84 to control the operation of the droplet generator 12 and, in particular, the operation of the jetting dispenser 60 and, if needed, includes an ADC to convert analog signals into a usable digital form.

The computer 24 analyzes the electrical signals communicated from the displacement sensor 114 to indicate, for example, an irregularity or variation in the operation of the jetting dispenser 60. As a specific example, the computer 24 may compare a standard vibration output or reference to the analyzed movement output communicated from the displacement sensor 114 and, based upon the result of the comparison, indicate an irregularity in the operation of the jetting dispenser 60. The computer 24 may adjust operation of the droplet generator 12 and/or the jetting dispenser 60 to compensate for any detected changes in the movement (i.e., displacement distance, velocity, acceleration) of shaft 68. For example, the displacement distance of the shaft 68 may change over time as the shaft 68 and the bushings and guides (not shown) in contact with the shaft 68 experience wear and/or changes in static and dynamic friction and stiction.

The displacement sensor 114 may be integrated into the shaft 68 of the needle valve 62, or surface mounted to shaft 68, and ride with the shaft 68 during movement between opened and closed positions of the lower end 72 relative to valve seat 74. Alternatively, the displacement sensor 114 may operate in a non-contact manner and may be placed at any location in the jetting dispenser 60 suitable for detecting shaft motion, such as placement inside of the air cylinder 66.

The computer 24 may respond to the displacement information communicated from the displacement sensor 114 by instructing the droplet generator controller 84 to change the properties of the jetting dispenser 60 of the droplet generator 12. For example, the computer 24 may command the controller 84 to operate the motor 81 to adjust the micrometer screw 80 for increasing or decreasing the upper limit of the stroke of the air piston 64 and, therefore, the stroke length of the shaft 68. In addition or instead of this stroke length adjustment, the controller 84 may instruct the droplet generator controller 84 to operate the motor 81 to change the initial spring compression of return spring 76 and preloading for the needle valve 62 by adjusting the micrometer screw 80.

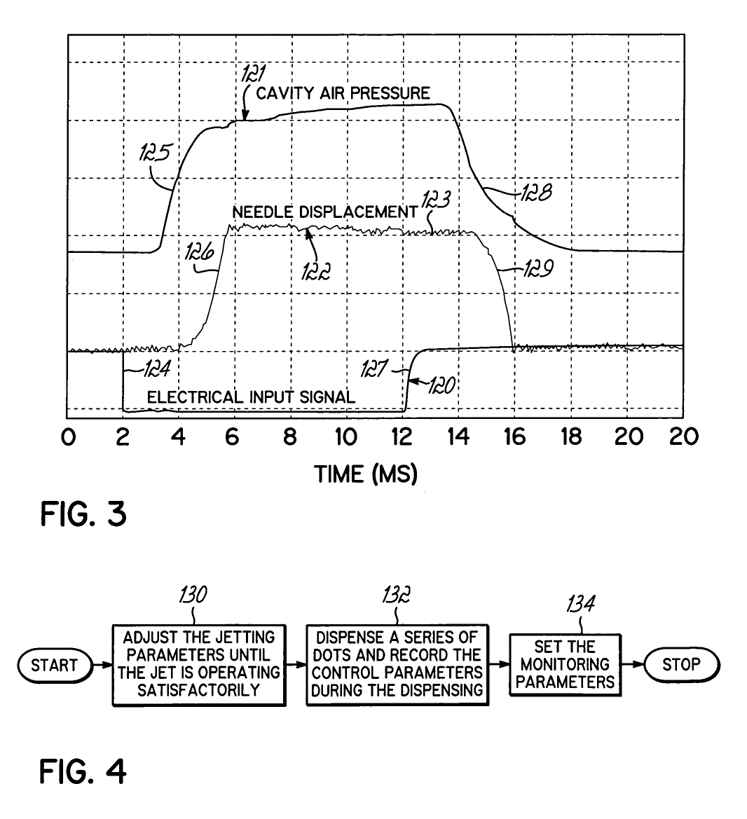

With reference to FIG. 3, a diagram is shown that is representative the operation of air pressure sensor 110 and displacement sensor 114 in system 10. Trace 120 represents a time profile of the electrical signals sent from the droplet generator controller 84 to the transducer 85 under command from computer 24. The controller 84 sends an electrical output pulse, which is represented by a falling shoulder 124 in trace 120 at about 2 milliseconds, to the transducer 85 to initiate a cycle to open the needle valve 62 for jetting one amount of viscous material from the jetting dispenser 60.

Trace 121 represents the flow of pressurized air into the air cylinder 66, as measured by the pressure sensor 110. After a time delay or response time that is characteristic of the particular transducer 85 and that is about 1½ milliseconds for the representative transducer 85, the transducer 85 responds to the output pulse from controller 84 by porting a pulse of pressurized air into the air cylinder 66. The pulse of pressurized air is reflected by a rise in the air pressure rises in air cylinder 66 at a time of about 3½ milliseconds, as indicated by a rising portion 125 in trace 121. The pressurization of air cylinder 66 eventually produces a rapid lifting of the air piston 66 that lifts the lower end 72 of the shaft 68 away from valve seat 74 and further compresses the return spring 76. Trace 122 represents the displacement of the shaft 68. The motion of the shaft 68, which lags the pressurization of the air cavity in air cylinder 66, opens the needle valve 62, as indicated by a rising portion 126 in trace 122.

After the needle valve 62 is opened, the shaft 68 is stationary between a time of about 6 milliseconds and a time of about 14¼ milliseconds, as indicated by the plateau 123 in trace 121. After a dispenser on-time, which is about 11 milliseconds in the representative embodiment (i.e., from a time of about 5 milliseconds when shaft 68 begins to move from the closed position to a time of about 16 milliseconds when shaft 68 has returned to the closed position), that relates to the volume of viscous material contained in amount 48 and under the command of computer 24, the controller 84 sends an output pulse to the transducer 85 that is represented by a rising shoulder 127 at about 12 milliseconds visible in trace 120. This instructs the transducer 85 to initiate a cycle to close the needle valve 62 by venting the fluid pressure inside the air cavity inside air cylinder 66. After a time delay for actuation of the transducer 85, the fluid pressure inside the air cylinder 66 drops as pressurized air is vented and as indicated by the pressure drop visible in trace 121 as a falling shoulder 128 between about 13.5 milliseconds and about 16.5 milliseconds. After the fluid pressure acting on the air piston 64 has fallen sufficiently, the shaft 68 will begin to translate or move, as indicated by the displacement denoted by a falling shoulder 129 in trace 122 spanning the time period between about 14 milliseconds and about 16 milliseconds, toward the closed position. The needle valve 62 closes at about 16 milliseconds, as denoted by the abrupt halt to shaft displacement and the termination of falling shoulder 129 as the lower end 72 of shaft 68 contacts the valve seat 74. As the needle valve 62 over the portion of trace 122 in falling shoulder 129, the amount 48 of viscous liquid is jetted toward the substrate 18.

The rate change or slope of the rising and falling shoulders 125, 128 of trace 121 and/or the rising and falling shoulders 126, 129 of trace 122 may be used to diagnose and track deterioration and wear of system components. For example, a significant change (e.g., increase or decrease) in slope may indicate an increase of that a system component is wearing abnormally fast or that a system component has experienced wear to a near-failure condition. As a specific example, a change in the slope of the rising and falling shoulders 126, 129 in trace 122 may indicated wear on the shaft 68 or supporting bearings and guides. Consequently, the need for system maintenance may be monitored independent of an actual system failure.

With reference to FIG. 4, an exemplary procedure flow is shown for operating the system 10 to perform a production run while monitoring parameters characterizing system operation with the assistance of information supplied from one or more of sensors 110, 112, 114. In block 130, droplet generator controller 84 adjusts the jetting parameters of droplet generator 12 under the control of computer 24 until the system 10 is operating satisfactorily by dispensing amounts 48 of viscous material consistent with the programmed amounts. In block 132, the computer 24 commands the motion controller 32 to move the droplet generator 12 such that the nozzle 98 is directly over one of the substrates 18. To initiate a production run, the computer 24, among other things, commands the droplet generator controller 84 to cause the droplet generator 12 to dispense multiple amounts 48 of viscous material that eventually impact the surface 37 of the substrate 18, while also commanding the motion controller 32 to cause the X-Y-Z drives 16 to move the droplet generator 12 across the surface of the substrate 18.

As the amounts 48 are dispensed from jetting dispenser 60, one or more of the sensors 110, 112, 114 sense or monitor the associated parameter (i.e., fluid pressure in the air cavity of air cylinder 66, vibration of the jetting dispenser 60, displacement of shaft 68) and transfer corresponding electrical output signals to the computer 24 for analysis. Initially, the measured values of the parameters are representative of system 10 operating under desired or satisfactory operating conditions. In block 134, the system 10 places these desired operating conditions in an archive stored in the memory 25 of computer 24 as reference standards for comparisons with future measured values of each monitored parameter. Under the supervision of the computer 24, the jetting system 10 sequentially dispenses amounts 48 of viscous material onto a series of substrates 18 while monitoring system operation using at least one of the sensors 110, 112, 114. Future measurements of the monitored parameters are compared with the parameter values measured under satisfactory operating conditions.

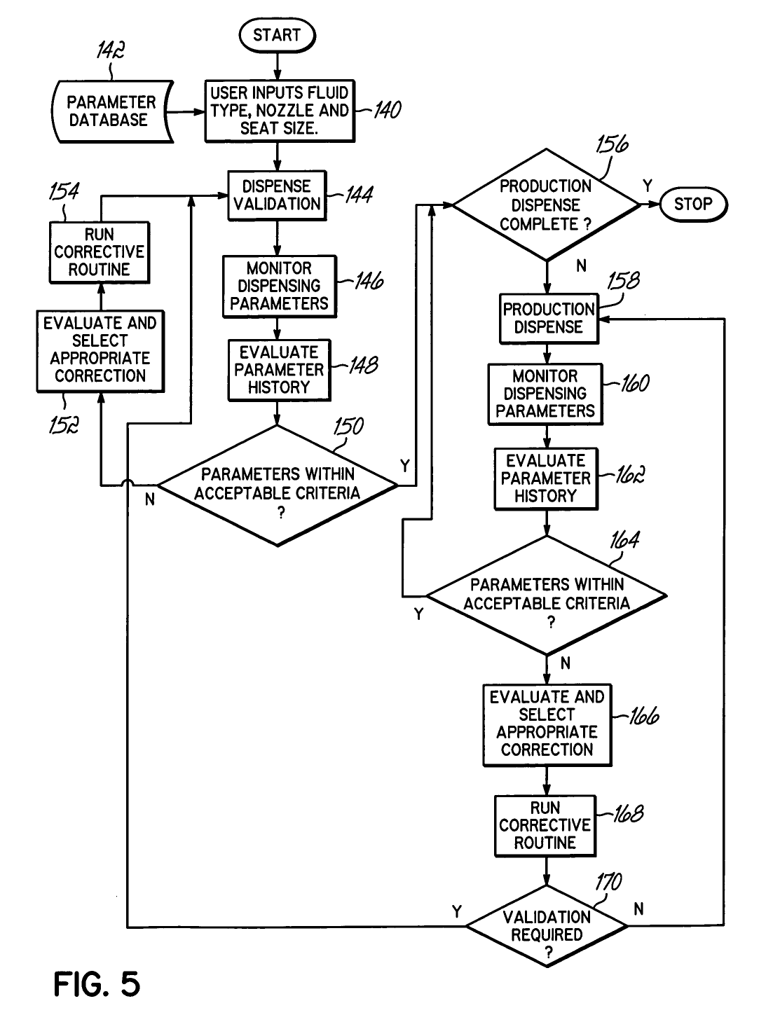

With reference to FIG. 5, a routine for operating the system 10 is shown in which the sensed parameters from at least one of the sensors 110, 112, 114 and uses the measured values of the sensed parameters to assist in system setup and to control the operation of system 10 during a production run. In block 140 and as part of a setup subroutine, an operator inputs basic information, such as fluid type, nozzle size, and seat size into the computer 24. In block 142, the computer 24 queries a library of operational cycles or sequences stored in the memory 25 of computer 24 and/or other computers (not shown). Further, the computer 24 may retrieve those operational sequences and substitute them in a particular operational program as desired. The computer 24 may also further tune the operational sequences to accommodate different environmental conditions, different substrates, or different viscous materials. In particular, the operational sequence may reflect the fluid type, nozzle size, and seat size entered by the user. In addition, during operation, the computer 24 may transfer a whole operational program to the motion controller 32 for execution, or the computer 24 can transfer one or more instructions in a batch of instructions and data to the motion controller 32 for execution.

In block 144, the computer 24 provides command signals to the motion controller 32 directing controller 32 to move the droplet generator 12 so that the nozzle 98 is over the table 56 of the weigh scale 58. Thereafter, the computer 24 causes the droplet generator controller 82 to operate the droplet generator 12 to dispense a number of amounts 48 onto the table 56 of the weigh scale 58. The operating parameters of the jetting dispenser 60 may be a default set of operating parameters or may be among archived information stores in memory 25 of computer 24 and retrieved for use in block 142. At the conclusion of the jetting process, the computer 24 reads or samples a weight output signal communicated from the weigh scale 58, which represents the weight of the dispensed amounts 48. Knowing the number of discrete amounts 48 dispensed, the computer 24 is then able to determine the weight of each jetted amount 48 and, consequently, the dot size.

In block 146, the computer 24 monitors the electrical output signals generated by, and communicated from, one or more of the sensors 110, 112, 114 as the amounts 48 are dispensed from jetting dispenser 60 and the sensors 110, 112, 114 monitor the dispensing process. These output signals are representative of the sensed dispensing parameters (i.e., fluid pressure in the air cavity of air cylinder 66, vibration of the jetting dispenser 60, displacement of shaft 68). In block 148, the computer 24 evaluates the dispensing parameters, taking into account any historical parameter information, and determines if the dispensing parameters are within acceptable criterion. Each of the parameters will typically have a range of permitted values bounded between upper and lower limits that represent acceptable criteria. In addition, because the dispensing parameters may be interrelated, the individual ranges may be contingent upon the sensed value of other dispensing parameters.

In block 150, if the sensed dispensing parameters are outside of the corresponding acceptable criteria, control is transferred to block 152 in which the computer 24 evaluates possible corrective actions and predicts an appropriate corrective action based upon the evaluation of the sensed parameters. Suitable corrective actions may include, but are not limited to, incrementing or decrementing the pressure of the fluid supplied to the air cylinder 66 or incrementing or decrementing the stroke length of the shaft 66. Other non-limiting corrective actions may include increasing or decreasing the temperature of the viscous material using temperature controller 90 or changing the pressure of the viscous material in supply reservoir 88 by operation of the voltage-to-pressure transducer 86.

In block 154, a corrective routine is executed by computer 24 to perform the appropriate correction action in an attempt to change the dot size. Next, control is returned to block 144 for dispense validation in which the computer 24 causes the droplet generator controller 82 to operate the droplet generator 12 to dispense a number of amounts 48 onto the table 56 of the weigh scale 58 and blocks 146-150 are repeated until the sensed dispensing parameters are within the acceptable criteria. If an erroneous dot size cannot be corrected, the system 10 may halt the production run and/or display a warning to the operator via alarm 35. This may be routed to computer 24 or, alternatively, may be routed to an alarm (not shown) independent of computer 24 or to kill power to the system 10.

In block 150, if the sensed dispensing parameters are within the corresponding acceptable criteria, then control is transferred to block 156 wherein the production run is commenced. As viscous material is dispensed onto the substrates 18, a check is made in block 150 to determine if the production run is complete. In block 158, the computer 24 commands the conveyor controller 42 to operate the conveyor 22 and transport a first of the substrates 18 to a fixed position within the jetting system 10. The computer 24 provides command signals to the motion controller 32 directing controller 32 to move the droplet generator 12 so that the nozzle 98 is over a first of the substrates 18. In a known manner, the video camera of the video camera and light ring assembly 34 communicates one or more images of the substrate 18 through the vision circuit 36 to the computer 24. The computer 24 locates fiducial marks on the substrate 18 visible in the image(s) and corrects for any substrate misalignment to ensure movement of the conveyor 22 accurately positions the substrate 18 so that the jetted amounts 48 strike the substrate 18 at the desired positions. Thereafter, the computer 24 causes the droplet generator controller 82 to operate the droplet generator 12 for dispensing a number of amounts 48 onto the first substrate 18, and then a series of additional substrates 18, in accordance with the pre-programmed dispensing profile.

In block 160, the sensors 110, 112, 114 monitor the dispensing process as the amounts 48 are dispensed from jetting dispenser 60. The computer 24 monitors the electrical output signals generated by, and communicated from, one or more of the sensors 110, 112, 114, which are representative of the sensed dispensing parameters (i.e., fluid pressure in the air cavity of air cylinder 66, vibration of the jetting dispenser 60, displacement of shaft 68, respectively). In block 162, the computer 24 evaluates the dispensing parameters, taking into account any historical parameter information, and determines if the dispensing parameters are within acceptable criterion. Each of the parameters will typically have a range of permitted values bounded between upper and lower limits that represent acceptable criteria. In addition, because the dispensing parameters may be interrelated, the individual ranges may be contingent upon the sensed value of other dispensing parameters.

In block 164, if the sensed dispensing parameter(s) are within the corresponding acceptable criteria, control is returned to block 152 to continue the production run. For each successive substrate 18 or for a fraction of the substrates 18, blocks 146-150 are repeated until the dispensing run concludes or the dispensing run is terminated by the operator. If the sensed dispensing parameter(s) are outside of the corresponding acceptable criteria, control is transferred by block 164 to block 166 in which the computer 24 evaluates possible corrective actions and predicts an appropriate corrective action. Suitable corrective actions may include, but are not limited to, incrementing or decrementing the pressure of the fluid supplied to the air cylinder 66 or incrementing or decrementing the stroke length of the shaft 66. In block 168, the computer 24 causes execution of a corrective routine to perform the correction action in an attempt to remedy the out-of-tolerance dispensing parameter. In block 170, control may be returned to block 158 to continue the production dispense if validation is not required. However, validation may be required if the corrective action is ineffective. In this instance, the production run is interrupted and block 170 transfers control to block 144 to initiate another dispense validation. Optionally, if a significant deviation in one or more of the parameters cannot be corrected, the system 10 may halt the production run and/or display a warning to the operator via alarm 35.

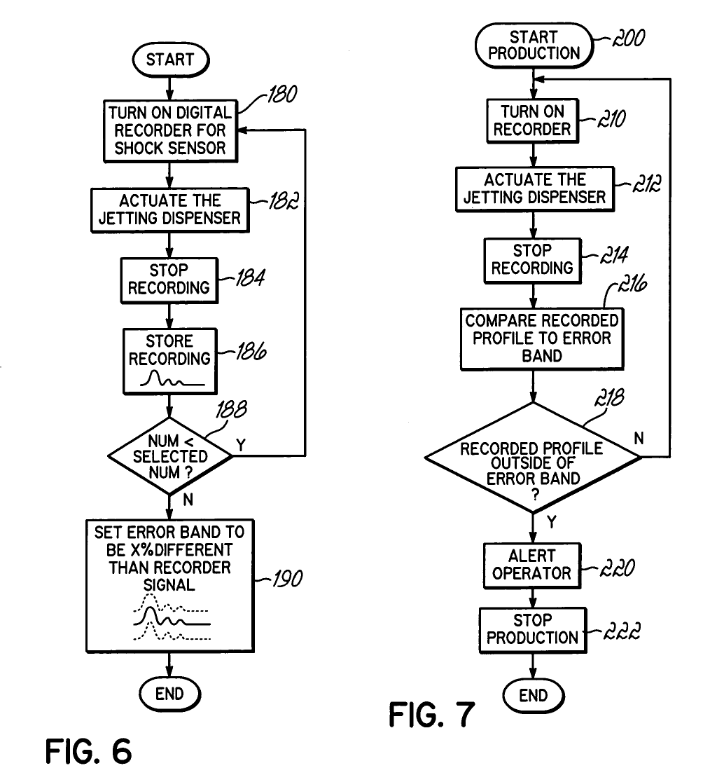

With reference to FIG. 6, a flow chart is shown that generally illustrates an embodiment of a procedure for setting up the system 10 using the vibration sensor 112 to monitor the performance of the droplet generator 12. In block 180, a digital recorder, which may be circuitry in computer 24 or other external circuitry electrically coupled with computer 24, is switched on to monitor the output signals from the vibration sensor 112. The computer 24 provides command signals to the motion controller 32 directing controller 32 to move the droplet generator 12 so that the nozzle 98 is over, for example, the table 56 of the weigh scale 58. In block 182, the computer 24 causes the droplet generator controller 82 to operate the droplet generator 12 to dispense a number of amounts 48 from the jetting dispenser 60.

The recording of the vibration is stopped in block 184 and the vibration profile as a function of time is stored in block 186. The vibration profile may include the sensed vibration for a single cycle to dispense one amount 48 or, preferably, may represent a statistical average for multiple cycles dispensing several amounts 48 of viscous material, as indicated in block 190. Block 190 transfers control back to block 180 is one or more amounts 48 have yet to be dispensed. In block 190, an error band is set for vibration amplitude that is a given percentage (i.e., X %) larger and smaller than the sensed vibration profile. This error band will operate as a reference standard during an actual production run.

With reference to FIG. 7, a flow chart is shown that generally illustrates an embodiment of a procedure for operating the system 10 during a production run using the vibration sensor 112 to monitor the performance of the droplet generator 12. In block 200, the computer 24 commands the conveyor controller 42 to operate the conveyor 22 and transport a first of the substrates 18 to a fixed position within the jetting system 10. The computer 24 provides command signals to the motion controller 32 directing controller 32 to move the droplet generator 12 so that the nozzle 98 is over a first of the substrates 18. In a known manner, the video camera of the video camera and light ring assembly 34 communicates one or more images of the substrate 18 through the vision circuit 36 to the computer 24. The computer 24 locates fiducial marks on the substrate 18 visible in the image(s) and corrects for any substrate misalignment to ensure movement of the conveyor 22 accurately positions the substrate 18 so that the jetted amounts 48 strike the substrate 18 at the desired positions.

In block 210, the digital recorder is switched on to monitor the output signals from the vibration sensor 112. In block 212, the computer 24 causes the droplet generator controller 82 to operate the droplet generator 12 for dispensing a number of amounts 48 onto the first substrate 18 in accordance with the pre-programmed dispensing profile. In block 214, the digital recorder is switched off to stop vibration recording and, in block 216, the recorded profile is compared with the error band established by the setup procedure of FIG. 6.

In block 218, control is transferred back to block 210 and blocks 210-218 are repeated if the result of the comparison indicates that the recorded profile is within the error band. However, if the recorded profile is outside of the error band, block 218 transfers control to block 220 in which an operator is notified of the anomaly by displaying an alarm on alarm indicator 35. An equipment failure may produce a recorded profile that is outside of the error band. Production is then stopped in block 222.

In accordance with the principles of the invention, one or more of the measured parameters of fluid pressure in the air cylinder, the dispenser vibration, and/or needle valve displacement may be used to troubleshoot a malfunctioning jetting dispenser. This diagnostic capability may be implemented locally or the parameters may be transmitted over, for example, the World Wide Web to a technician at a remote location. The measured parameters may enable the technician to diagnose and remedy the jetting difficulty. The diagnosis using the measured parameters may confine the origin of the malfunction to the dispenser, as opposed to the system circuitry or the jetted material, which may simplify the diagnostic procedure for the technician.

One or more of the measured parameters may also be used to provide feedback directly to the system controller for adjusting the jetting process during system operation and without operator intervention by either the end user or a technician. This capability reduces the need to educate the end user with the ability to diagnose jetting difficulties. The measured parameters may be used during the initial tool setup for establishing operating conditions either in an automated manner by communicating directly with the software executing on the controller or computer, or to display feedback directly to the operator for the operator's used in setting operational parameters.

In addition to the embodiments of the invention described herein, it is contemplated that the principles of the invention are applicable to other module designs and operating mechanisms including, but not limited to, electrically-actuated dispensing modules and operating mechanisms. While the above may be a preferred pneumatically-actuated dispensing module, the principles of the invention are generally applicable to any pneumatically-actuated, electrically-actuated, or electropneumatically-actuated dispensing module. While the above may be a preferred jetting dispenser, the principles of the invention may be generally applicable to any pneumatically-actuated, electrically-actuated, or electropneumatically-actuated dispensing module.

References herein to terms such as “vertical”, “horizontal”, etc. are made by way of example, and not by way of limitation, to establish an absolute frame of reference. In particular, the Cartesian coordinate frame established by the X, Y and Z axes of motion 20, 21, and 22, defined herein is exemplary and used for convenience of description. It is understood by persons of ordinary skill in the art that various other frames of reference may be equivalently employed for purposed of describing the present invention.

While the present invention has been illustrated by a description of various preferred embodiments and while these embodiments have been described in considerable detail in order to describe the best mode of practicing the invention, it is not the intention of applicants to restrict or in any way limit the scope of the appended claims to such detail. Additional advantages and modifications within the spirit and scope of the invention will readily appear to those skilled in the art. The invention itself should only be defined by the appended claims, wherein we claim:

1. A system for jetting a viscous material, comprising:
an electronic controller;
a jetting dispenser operatively coupled with said electronic controller, said jetting dispenser including an outlet orifice and an actuator with a movable shaft, and said jetting dispenser operative under control of said electronic controller for causing said actuator to jet an amount of the viscous material from said outlet orifice; and
a displacement sensor configured to sense movement of said movable shaft and produce an output signal representative of the sensed movement.

2. The system of claim 1 wherein said displacement sensor is electrically coupled with said electronic controller for communicating said output signal to said electronic controller.

3. The system of claim 2 wherein said electronic controller is configured to compare a standard output representative of a satisfactory movement of said movable shaft to said output signal communicated from said displacement sensor, said controller being configured to indicate a change in the operation of said jetting dispenser from the comparison.

4. The system of claim 2 wherein said output signal is a profile representing displacement of said movable shaft as a function of time.

5. The system of claim 2 wherein said electronic controller includes a display that visually displays said output signal communicated from said displacement sensor.

6. The system of claim 1 wherein said actuator is an electro-pneumatic actuator.

7. A system for jetting a viscous material, comprising:
an electronic controller;
a jetting dispenser operatively coupled with said electronic controller, said jetting dispenser including a outlet orifice and an actuator with an air cylinder and an air piston positioned in said air cylinder, and said jetting dispenser operative under control of said electronic controller for causing said actuator to jet an amount of the viscous material from said outlet orifice; and
a pressure sensor configured to sense a fluid pressure inside said air cylinder and produce an output signal representative of the sensed fluid pressure.

8. The system of claim 7 wherein said pressure sensor is electrically coupled with said electronic controller for communicating said output signal to said electronic controller.

9. The system of claim 8 wherein said electronic controller is configured to compare a standard output representative of a satisfactory fluid pressure inside said air cavity to said output signal communicated from said pressure sensor, said controller being configured to indicate a change in the operation of the jetting dispenser from the comparison.

10. The system of claim 8 wherein said output signal is a profile representing fluid pressure in said air cylinder as a function of time.

11. The system of claim 8 wherein said electronic controller further comprises a display that visually displays said output signal communicated from said pressure sensor.

12. A system for jetting a viscous material, comprising:
an electronic controller;
a jetting dispenser operatively coupled with said electronic controller, said jetting dispenser including an outlet orifice and an actuator, and said jetting dispenser operative under control of said electronic controller for causing said actuator to jet an amount of the viscous material from said outlet orifice; and
a vibration sensor configured to sense vibration of said jetting dispenser during operation.

13. The system of claim 12 wherein said vibration sensor is further configured to produce an output signal representative of the sensed vibration.

14. The system of claim 13 wherein said vibration sensor is electrically coupled with said electronic controller for communicating said output signal to said electronic controller.

15. The system of claim 14 wherein said electronic controller is configured to compare a standard output representative of a satisfactory vibration of said jetting dispenser to said output signal communicated from said vibration sensor, said controller being configured to indicate a change in the operation of the jetting dispenser from the comparison.

16. The system of claim 14 wherein said electronic controller further comprises a display that visually displays said output signal communicated from said vibration sensor.

17. The system of claim 12 wherein said vibration sensor includes an accelerometer.

18. The system of claim 12 wherein said actuator is an electro-pneumatic actuator.

19. The system of claim 12 wherein said jetting dispenser further comprises a shaft coupled with said actuator, said shaft movable when said actuator jets the amount of the viscous material from said outlet orifice, and said vibration sensor is mounted to said movable shaft.

20. The system of claim 19 wherein said jetting dispenser further comprises a valve seat, and said actuator moves a portion of said shaft into and out of contact with said valve seat to generate at least a portion of said vibration.

21. A method of operating a jetting system that includes a jetting dispenser having an actuator with an air cylinder and an air piston movable within the air cylinder and a control component operatively coupled with the jetting dispenser, the jetting system operating the actuator under the control of the control component to jet a viscous material from an outlet orifice of the jetting dispenser, the method comprising:
supplying pressurized fluid to the air cylinder effective to move the air piston relative to the air cylinder;
sensing a fluid pressure inside the air cylinder as the air piston moves within the air cylinder; and
communicating the sensed fluid pressure to the control component.

22. The method of claim 21 further comprising:
controlling the operation of the jetting dispenser in response to the sensed fluid pressure.

23. The method of claim 22 wherein controlling the operation of the jetting dispenser further comprises:
changing a fluid pressure of the pressurized fluid supplied to the air cylinder.

24. The method of claim 21 further comprising:
sensing the fluid pressure inside the air cylinder as a function of time.

25. The method of claim 24 further comprising:
determining a rate change in the sensed fluid pressure; and
indicating a change in the operation of the jetting dispenser based upon the determined rate change.

26. The method of claim 25 wherein the change represents an irregularity in the operation of the jetting dispenser.

27. The method of claim 21 further comprising:
comparing a standard fluid pressure to the sensed fluid pressure; and
indicating a change in the operation of the jetting dispenser from the comparison.

28. The method of claim 27 wherein the change represents an irregularity in the operation of the jetting dispenser.

29. A method of operating a jetting system that includes a jetting dispenser with a movable shaft and a control component operatively coupled with the jetting dispenser, the method comprising:
moving the movable shaft within the jetting dispenser;
sensing a displacement of the movable shaft during movement; and
communicating the sensed displacement to the control component.

30. The method of claim 29 further comprising:
controlling the operation of the jetting dispenser in response to the sensed displacement.

31. The method of claim 30 wherein controlling the operation of the jetting dispenser further comprises:
changing a stroke length of the movable shaft.

32. The method of claim 30 wherein controlling the operation of the jetting dispenser further comprises:
changing a preloaded spring bias applied to the movable shaft.

33. The method of claim 29 further comprising:
measuring the displacement of the movable shaft as a function of time.

34. The method of claim 33 further comprising:
determining a rate change in the measured displacement; and
indicating a change in the operation of the jetting dispenser based upon the determined rate change.

35. The method of claim 34 wherein the change represents an irregularity in the operation of the jetting dispenser.

36. The method of claim 33 further comprising:
comparing a standard displacement to the measured displacement; and
indicating a change in the operation of the jetting dispenser from the comparison.

37. The method of claim 36 wherein the change represents an irregularity in the operation of the jetting dispenser.

38. A method of operating a jetting system that includes a jetting dispenser with at least one movable component and a control component operatively coupled with the jetting dispenser, the method comprising:
moving the at least one movable component of the jetting dispenser;
sensing vibration of the jetting dispenser resulting from movement of the at least one movable component; and
communicating the sensed vibration to the control component.

39. The method of claim 38 further comprising:
controlling the operation of the jetting dispenser in response to the sensed vibration.

40. The method of claim 38 wherein measuring the vibration further comprises:
measuring an acceleration of the jetting dispenser as a function of time.

41. The method of claim 38 further comprising:
comparing a standard vibration profile to the sensed vibration; and
indicating a change in the operation of the dispenser from the comparison.

42. The method of claim 41 wherein the change represents an irregularity in the operation of the jetting dispenser.

43. The method of claim 38 wherein the movable component is an actuator operative to cause the jetting dispenser to jet an amount of a viscous material from an outlet orifice of the jetting dispenser.
